(19) United States
(12) Patent Application Publication
(10) Pub. No.: US 2008/0285124 A1
(43) Pub. Date: Nov. 20, 2008

(54) In-Plane Manipulator

(75) Inventor: Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,494

(22) PCT Filed: Oct. 3, 2006
(86) PCT No.: PCT/IB06/53612

§ 371 Date: Apr. 17, 2008

(30) Foreign Application Priority Data
Oct. 17, 2005 (EP) 05109606.3

(51) Int. Cl. G02B 21/26

(52) U.S. Cl. 359/391

(57) ABSTRACT

Manipulator (1) for displacing an object holder (4), which manipulator (1) comprises a base (2), an actuator (5), a transmission (7), a guide (11) and an object holder (4). The actuator (5) is connected to the base (2) and displaces the object holder (4) via the transmission (7) when operating the actuator (5). The guide (11) is connected to the base (2) and to the object holder (4) and adapted such that it guides the object holder (4) parallel to itself.

The present invention relates to a manipulator for displacing an object holder, comprising a base, an actuator connected to the base, which actuator has an actuating portion which is displaced with respect to the base when operating the actuator, a transmission which is connected to said actuating portion of the actuator and to a first connecting portion of the object holder for converting a displacement of the actuating portion into a displacement of the first connecting portion along a predetermined line of displacement, and a guide which is connected to the base and to a second connecting portion of the object holder spaced from the first connecting portion so as to guide the object holder parallel to itself.

Such a manipulator is known from the Japanese patent JP07-035987. This prior art document discloses a manipulator which is provided with an adjusting mechanism for displacing a stage. The mechanism converts a horizontal displacement of an actuator into a vertical displacement of the stage, whereas guiding elements guide the stage when it is displaced. The mechanism provides a low construction height of the manipulator. A disadvantage of the known manipulator is the relatively limited range in which an accurate vertical displacement of the stage is possible.

It is an object of the present invention to provide a manipulator which enables a displacement of the object holder over a wide displacement range.

To obtain this object, the guide is adapted such that the second portion of the object holder is forced to displace synchronously with the first portion substantially parallel to the defined line of displacement.

Due to the feature that both the first connecting portion and the second connecting portion are displaceable parallel to each other and synchronously the object holder is displaceable parallel to itself in a relatively simple manner. As a consequence thereof, the orientation of the object holder is not influenced by a displacement. Thus, even with relatively large displacements, an accurate orientation of the object holder is maintained. Therefore, a wide displacement range is made possible.

The embodiment of claim 2 wherein the transmission and the guide are positioned parallel to each other is a further simplification of the construction.

The embodiment of claim 3 includes a lever. An advantage of applying a lever is that it enables a conversion of a displacement in one direction into a displacement perpendicular thereto such that the manipulator may have a low construction height.

A preferred embodiment of the guide comprises at least a first set of at least two guide arms, such as defined in claim 4. The set of two guide arms together with the second portion of the object holder and the base form a four-rod linkage, wherein the guide arms and the guide arm hinge portions are arranged such that the four-rod linkage forms a parallelogram. This configuration and the other features according to claim 4 have the advantage of a simple mechanical construction which ensures a displacement of the object holder parallel to itself.

In a favourable embodiment according to claim 5 the guide arms are arranged such that the effective guide arm lines extend in a plane substantially parallel to the plane of displacement. This configuration avoids a moment arm between the guide arms in a direction perpendicular to the plane of displacement, which could have led to deformation of the object holder or the guide during and after a displacement.

An advantage of the configuration according to claim 6 is an improved stiffness of the guide in a direction perpendicular to the plane of displacement.

A favourable embodiment is defined in claim 7. An advantage resulting from this embodiment is a further improved structural stiffness of the guide in a direction perpendicular to the plane of displacement. Besides, the guide is reinforced in direction of rotation about a line parallel to the effective guide arm lines.

A further improvement of the manipulator performance is achieved with the configuration according to claim 8. The compensation member serves to introduce a compensation force on the object holder during and after its displacement in order to reduce a bending moment of the guide about the effective lever line as a consequence of stiffness of the guide in a direction parallel to the line of displacement. Applying an appropriate stiffness of the compensation member prevents the object holder from tilting.

The embodiment according to claim 9 contributes to a low construction height of the manipulator.

According to claim 10 the actuator comprises a piezo element. This type of actuator is known in the art and can be actuated by an electric current which results in a longitudinal displacement of the actuating portion. As a consequence of the arrangement according to the embodiment of claim 10 the first connecting portion of the object holder is displaceable in a direction substantially perpendicular to the displacement of the actuating portion. This may lead to further reduction of the construction height of the manipulator.

The embodiment of claim 11 has the advantage that the displacement of the first connecting portion is amplified with respect to the displacement of the actuating portion. This provides the opportunity to reduce the length of the piezo element.

According to claim 12 the spring over the piezo element is preferably a substantially flat wire spring. This further reduces the construction height of the manipulator.

An advantage of the embodiment according to claim 13 is also that the construction height of the manipulator can be kept low.

An advantage of the embodiment according to claim 14 is that it provides a manipulator in which the object holder is displaceable in three dimensions with respect to the frame.

The invention also relates to an apparatus, such as an optical apparatus, an optical storage apparatus and an apparatus for microscopic analysis, e.g. biomedical analysis. The apparatus according to the invention is provided with the manipulator according to the invention.

These and other aspects and advantages of the invention will be apparent from the following description with reference to the schematical drawings.

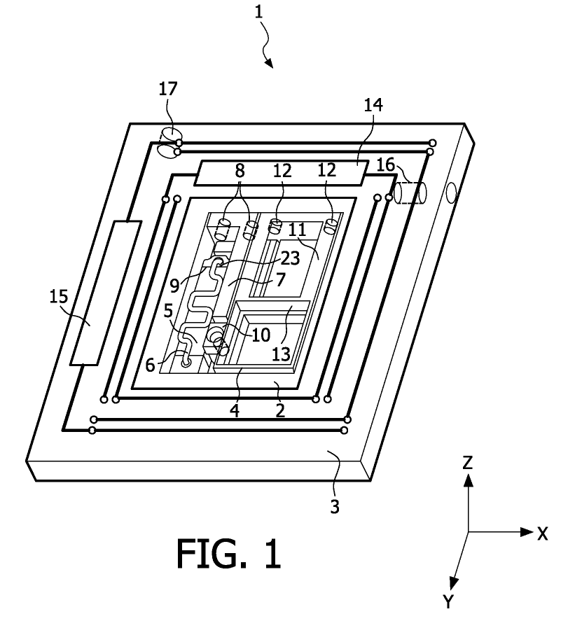

FIG. 1 is a perspective plan view of a manipulator according to the invention.

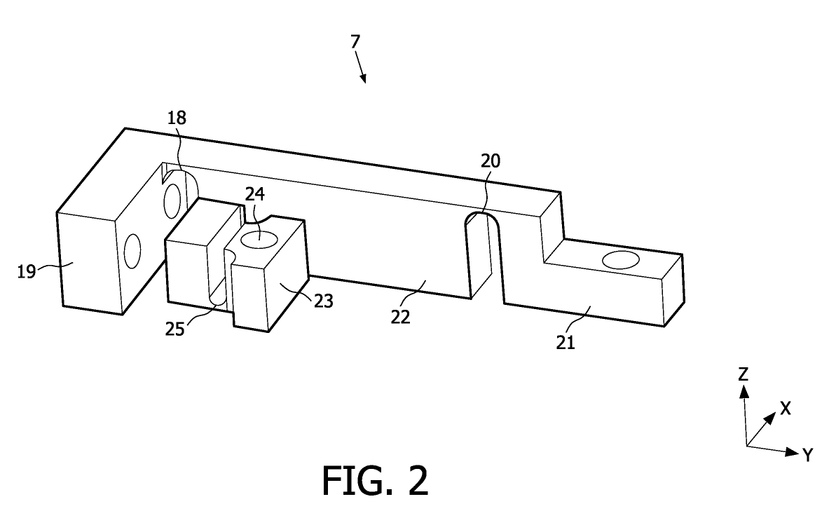

FIG. 2 is a perspective side view of a lever arrangement according to the invention.

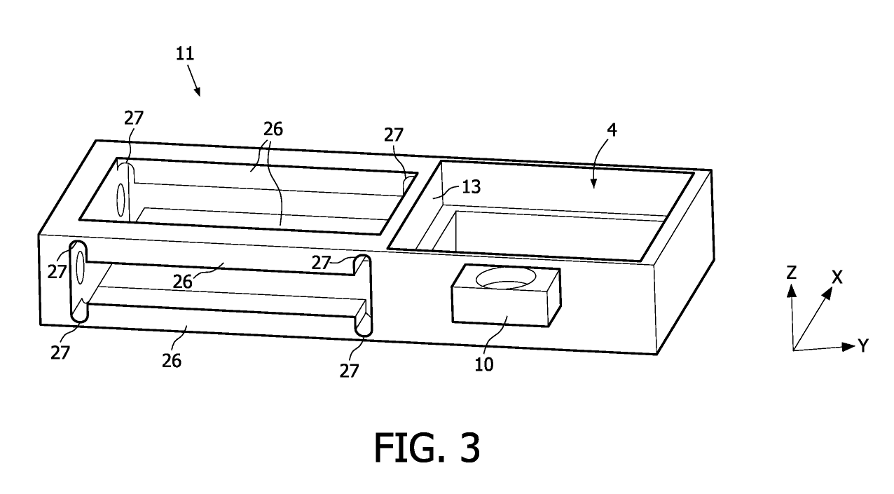

FIG. 3 is a perspective plan view of the object holder and the guide according to the invention.

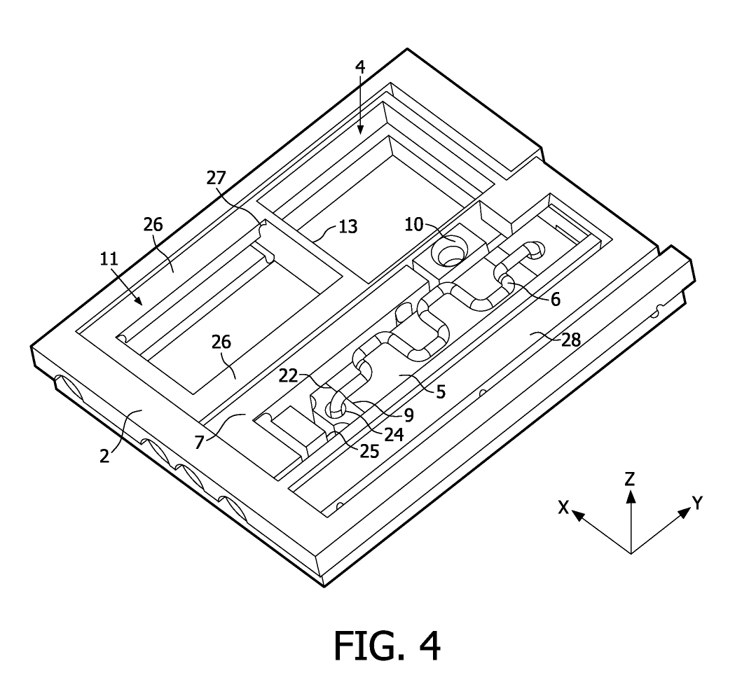

FIG. 4 is a perspective plan view of an alternative embodiment of the manipulator according to the invention.

FIG. 1 shows an embodiment of a manipulator 1 in accordance with the invention. The manipulator may be part of an apparatus. The embodiment represents an in-plane manipulator which is intended for use in an apparatus, for example, in optical storage devices to move light spots in X, Y direction and to focus them in Z direction. Another application field is microscopic analysis, such as for biomedical analysis as accurate small displacements are achieved with this type of manipulator. The embodiment of FIG. 1 comprises a base 2 which is mounted to a flat frame 3, such that the manipulator 1 forms a plate-like arrangement extending parallel to the X, Y plane. The frame 3 is or may be secured to a mounting part 5 of an apparatus. The base is displaceable with respect to the frame in X, Y direction. The type of frame 3 is known in the art and has the advantage of accurate controllable displacements in X and Y direction without play. The manipulator 1 includes an object holder 4, which is displaceable in X, Y, Z direction with respect to the frame 3. In practice, the object holder 4 may bear a sample to be analysed by microscopy, for example. The object holder 4 in the embodiment of FIG. 1 has a flat upper surface and is located parallel to the frame 3. It is displaceable in Z direction with respect to the base 2 by a piezo element 5.

Generally piezo elements are bar-shaped. When actuated by an electric current, the end portions of a piezo element are displaceable with respect to each other in longitudinal direction of the bar. From idle state (this means: it is not electrically charged) a piezo element can only be elongated. In order to enable a displacement into two opposite longitudinal directions piezo elements are generally subjected to a pre-load, which compresses the piezo element, and bear an electric voltage when they have a reference length. An elongation with respect to the reference length is then achieved by increasing the electric voltage and a shortening with respect to the reference position is achieved by decreasing the electrical voltage.

The embodiment shown in FIG. 1 includes a pre-load spring 6, which is placed over the piezo element 5. The pre-load spring 6 is a flat wire spring so as to minimize the height of the manipulator 1 in Z direction. The spring 6 can be made of spring steel, preferably specified by UN-N1026/85.

As a piezo element can only be actuated in its longitudinal direction, such as mentioned above, the piezo element 5 extends in Y direction and a lever arrangement 7 converts a length change of the piezo element 5 in Y direction into a displacement of the object holder 4 in Z direction. The lever arrangement 7 is fixed at three locations: to the base 2 in the lever connecting points 8, to an actuating portion 9 of the piezo element 5 and to a first connecting portion 10 of the object holder 4.

The manipulator 1 also has a guide 11 which guides the object holder 4 parallel to itself when it is displaced with respect to the base 2 by the piezo element 5. Therefore, one side of the guide 11 is fixed to the base 2 with guide connectors 12 and the other side to a second connecting portion 13 of the object holder 4.

The base 2 is displaceable with respect to the frame 3 in X, Y direction by piezo elements 14, 15 respectively. The pre-load springs 16, 17 are coiled springs and are provided to enable displacements in −X and −Y direction of piezo elements 14, 15, respectively, as explained above.

The lever arrangement 7 is shown in FIG. 2. The lever arrangement 7 has a first lever hinge portion 18 adjacent to a first end portion 19 and a second lever hinge portion 20 adjacent to a second end portion 21, which is opposite to the first end portion 19. The first end portion 19 is fixed to the base 2, whereas the second end portion 21 is fixed to the object holder 4, see FIG. 1. A lever 22 extends between the first and second lever hinge portions 18, 20. The lever 22 is provided with an action point 23, against which the actuating portion 9 of piezo element 5 may exert a force in −Y direction. The lever 22 is also provided with a hole 24 in which the pre-load spring 6 is engaged. When an electrical charge, which was introduced earlier on the piezo element 5, is reduced the pre-load spring 5 will compress thus exerting a force on a portion of the lever 22 adjacent to the hole 24 in +Y direction.

The action point 23 as well as the top of the hole 24 are located in a lower position than the first lever hinge portion 18 viewed in Z direction. Note that in FIG. 2 the action point 23 represents a point in an X, Z plane on which a force of the piezo element 5 effectively acts. Therefore, when actuating the piezo element 5 from a charged condition, by increasing or decreasing the electrical voltage, the action point 23 displaces in +Y or −Y direction, respectively. The resulting moment acting on the lever 22 about the first lever hinge portion 18 will rotate the lever 22 about the axis of the first lever hinge portion 18 within the Y, Z plane.

Since the actuating portion 9 of the piezo element 5 has to move in +Y or −Y direction and, as a result of the lever movement, also in +Z or −Z direction the piezo element 5 is rotatably connected to the action point 23 and the base 2 by hinges 25.

As the second end portion 21 of the lever arrangement 7 is fixed to the first connecting portion 10 of the object holder 4, the first connecting portion 10 is also rotatable about the axis of the first lever hinge portion 18, thus enabling a displacement in +Z and −Z direction. It is, however, desired to keep the object holder 4 parallel to the X, Y plane. Therefore, the object holder 4 is rotatably connected to the lever 22 by the second lever hinge portion 20. If, for example, the lever 22 is rotated upwardly through a certain angle about the axis of the first lever hinge portion 18, the object holder 4 should rotate downwardly with respect to the lever 22 through the same angle about the axis of the second lever hinge portion 20 so as to enable a displacement in Z direction of the object holder 4 while the object holder 4 remains parallel to itself. This forced displacement of the object holder 4 is achieved by the guide 11.

The dimensions of the lever 22 may be optimised in terms of conversion ratio between the displacement of the first connecting portion 10 of the object holder 4 in +Z or −Z direction and the displacement of the action point 23 in −Y or +Y direction, respectively. The conversion ratio can be increased by reducing the distance between the hinge 25 on the lever 22 and the first lever hinge portion 18 in Z direction and/or increasing the length of the lever 22 between hinge 25 on the lever 22 and the first and second lever hinge portions 18, 20. A higher conversion ratio has the advantage that the length of the piezo element 5 in Y direction can be limited. Since a higher force is needed in that case it will also require a higher electrical voltage on the piezo element 5.

In FIG. 3 the guide 11 and the object holder 4 of the embodiment of the manipulator 1 as shown in FIG. 1 are shown in more detail. In the embodiment of FIG. 3 the guide 11 and object holder 4 are integrated. The guide 11 is provided with four guide arms 26, which extend parallel to each other and are spaced in X and Z direction. The guide arms 26 are connected to the base 2 and to the second connecting portion 13 of the object holder 4. The guide arms 26 are positioned symmetrically: two guide arms 26 above each other in Z direction and two guide arms 26 next to each other in X direction.

Each of the guide arms 26 is provided with two guide arm hinge portions 27. The effective length of each guide arm 26 between the guide arm hinge portions 27 is equal to the effective length of the lever 22 between the first and second lever hinge portions 18, 20. An effective line of the guide 11, extending through the guide arm hinge portions 27 extends parallel to an effective line of the lever 22, extending through the lever hinge portions 18, 20. The object holder 4 is rotatably connected to the guide arms 26 by the guide arm hinge portions 27 adjacent to the second connecting portion 13 as well as to the lever 22 by the second lever hinge portion 20. The guide arms 26 and the lever 22 are also rotatably connected to the base 2 by the guide arm hinge portions 27 adjacent to the base 2 and the first lever hinge portion 18, respectively. As a consequence of the dimensions and the orientation of this configuration the object holder 4 stays parallel to itself when it is displaced in Z direction. Of course, a displacement in Z direction of the object holder guided by the guide arms 26 also leads to a displacement in −Y direction of the object holder 4. However, this can be easily compensated by a displacement of the base 2 with respect to the frame 3 in +Y direction.

In FIG. 4 an alternative embodiment of the manipulator 1 is shown. This embodiment includes a compensation lever 28, which compensates for the stiffness of the guide 11. Without this compensation lever 28 the guide 11 and the lever arrangement 7 are subjected to a bending moment about the Y axis through the first connecting portion 10 of the object holder 4 if this is displaced in Z direction. This may lead to deformation of the guide 11 thus a tilted orientation of the object holder. The bending moment is compensated by the compensation lever 28 of which one end portion is connected to the base 2 and the other end portion is connected to the object holder 4. The stiffness of the compensation lever 28 in Z direction and the distance between the lever 22 and the location to which it is connected to the object holder 4 in X direction can be optimised to reduce the bending moment on the guide 11 and the lever arrangement 7. This reduces the risk of tilting of the object holder 4.

The embodiment of the manipulator 1 according to FIGS. 1 and 4 may, for example, have the following dimensions: a length and width in X, Y direction of about 35 and 42 mm, respectively, and a height in Z direction of about 3 mm. The maximum stroke of the object holder 4 in + and −Z direction may be about 30 μm with an accuracy of 0.5 μm and a minimal stroke of 15 μm in X and Y direction with an accuracy of 50 nm.

The guide arm hinge portions 27 and the lever hinge portions 18, 20 can be made by spark erosion or by assembling different parts which can be fixed to each other by an adhesive agent or welding. The lever arrangement 7, guide 11, base 2 and frame 3 are preferably made of a metal, such as stainless steel or aluminium. These components can be fixed together by laser welding or adhesive agent, for example. The wired spring 6 can be made of a spring steel.

From the foregoing it will be clear that the invention provides an in-plane manipulator 1 which is able to displace the object holder 4 parallel to itself in a direction substantially perpendicular to the plane of the frame 3. Due to the features of the guide 11 a displacement over a wide range can be achieved.

The invention is not restricted to the above-described embodiments as shown in the drawings, which can be varied in several ways without departing from the scope of the claims. For example, the guide may be a fixed one, such as a guide track, which guides the first and second connection portion of the object. The guide arms could be two parallel wide arms located above each other in Z direction instead of four narrow arms. The hinges shown are living hinge-like hinges, but any type of hinge or pivot is conceivable as long as some kind of hinging action is obtained.

In general it is noted that, in this application, the expression “comprising” does not exclude other elements, and “a” or “an” does not exclude a plurality. Reference signs in the claims shall not be construed as limiting the scope thereof. Moreover, the invention relates to all possible combinations of features described in the set of claims.

1. Manipulator (1) for displacing an object holder (4), comprising a base (2), an actuator (5) connected to the base (2), which actuator (5) has an actuating portion (9) which is displaced with respect to the base (2) when operating the actuator (5), a transmission (7) which is connected to said actuating portion (9) of the actuator (5) and to a first connecting portion (10) of the object holder (4) for converting a displacement of the actuating portion (9) into a displacement of the first connecting portion (10) along a predetermined line of displacement, and a guide (11) which is connected to the base (2) and to a second connecting portion (13) of the object holder (4) spaced from the first connecting portion (10) so as to guide the object holder (4) parallel to itself, wherein the guide (11) is adapted such that the second portion (13) of the object holder (4) is forced to displace synchronously with the first connecting portion (10) substantially parallel to said line of displacement.

2. Manipulator (1) according to claim 1, wherein the transmission (7) and the guide (11) are positioned parallel to each other.

3. Manipulator (1) according to claim 2, wherein the transmission (7) includes a lever (22), of which one end portion is rotatably connected to the base (2) by a first lever hinge portion (18) and an opposite end portion is rotatably connected to the first connecting portion (10) of the object holder (4) by a second lever hinge portion (20), said lever (22) having an effective lever line extending through the first and second lever hinge portions (18, 20), whereas the lever (7) is rotatable with respect to the base (2) within a predetermined plane of displacement.

4. Manipulator (1) according to claim 3, wherein the guide (11) includes at least a first set of at least two guide arms (26), each of the guide arms (26) being rotatably connected to the second connecting portion (13) of the object holder (4) and to the base (2) by guide arm hinge portions (27) and has an effective guide arm line extending through the guide arm hinge portions (27), which effective guide arm line extends parallel to the effective lever line, whereas the length of each of the guide arms (26) between the guide arm hinge portions (27) is equal to the length of the lever (22) between said first and second lever hinge portions (18, 20) and the guide arms (26) are arranged such, that the effective guide arm lines are spaced in a direction perpendicular to themselves within a plane parallel to said plane of displacement.

5. Manipulator (1) according to claim 4, wherein the first set of guide arms (26) is arranged such that the effective guide arm lines extend in a plane, which is substantially parallel to said plane of displacement.

6. Manipulator (1) according to claim 4, wherein each guide arm hinge portion (27), having a hinge axis, connects the guide arm (26) to the second end portion (13) or connects the guide arm (26) to the base (2) at more than one location along the hinge axis.

7. Manipulator (1) according to claim 4, wherein the guide (11) includes at least a second set of at least two guide arms (26), which set is disposed in a plane spaced from the first set of guide arms (26) in a direction perpendicular to the plane of displacement.

8. Manipulator (1) according to claim 3, wherein the manipulator (1) includes a compensation member (28) which is resiliently connected to the base (2) and the object holder (4), adapted such that a displacement of the object holder (4) along the line of displacement results in a force component of the compensation member (28) on the object holder (4) opposite to the direction of displacement of the object holder (4) and acting remote from the first connecting portion (10) in a direction perpendicular to the plane of displacement, whereas the stiffness of the compensation member (28) in the direction of the line of displacement is adapted such that the object holder (4) is displaceable parallel to itself.

9. Manipulator (1) according to claim 8, wherein the compensation member (28) comprises a lever, at least partly extending substantially parallel to the effective lever line.

10. Manipulator (1) according to claim 3, wherein the actuator (5) comprises a piezo element of which the actuating portion (9) is connected to an action point (23) on the lever, which action point (23) is spaced from the first lever hinge portion (18) in a direction perpendicular to the effective lever line within a plane parallel to said plane of displacement.

11. Manipulator (1) according to claim 10, wherein the distance between the action point (22) and the effective lever line is shorter than the length of the lever (22) between the first and second lever hinge portions (18, 20).

12. Manipulator (1) according to claim 10, wherein a pre-load spring (6) is placed over the piezo element (5) and secured to the base (2) and the actuating portion (9), which spring (6) is preferably a substantially flat wire spring.

13. Manipulator (1) according to claim 1, wherein the base (2) extends parallel to a base plane and the object holder (4) is mounted next to the guide (11) and/or the transmission (7) and/or the actuator (5) viewed in a direction perpendicular to said base plane.

14. Manipulator (1) according to claim 1, wherein the base (2) is connected to a frame (3) and displaceable with respect thereto parallel to the base plane by means of at least two actuators (14, 15).

15. Apparatus provided with the manipulator according to claim 1.
